(19) United States
(12) Patent Application Publication
(10) Pub. No.: US 2017/0011428 A1
(43) Pub. Date: Jan. 12, 2017

(54) Age Related Marketing System and Method

(71) Applicant: Kenneth Wayne Guenther, Portland, OR (US)

(72) Inventor: Kenneth Wayne Guenther, Portland, OR (US)

(21) Appl. No.: 14/792,188

(22) Filed: Jul. 6, 2015

(51) Int. Cl. G06Q 30/02

(52) U.S. Cl. CPC G06Q 30/0271; G06Q 30/0255

(57) ABSTRACT

An age related marketing system and method based on selectively targeting those individuals from the older athletic crowd, that are most likely to purchase “athleisure” goods branded with the logo “Still Doing it”. It involves establishing a data lake of data from the public and private sectors relating to personal demographics along with indicators of athleticism and mobility and their personal purchasing and internet browsing preferences. An algorithim analyzes the data after placing a weighted value on each of the data that will result in an ordering of the data that most likely fits a profile model of the most likely consumer prepared by the seller.

### BACKGROUND OF THE INVENTION

When one thinks of trendy sporting shoes, apparel and related accessories, visions of high school and college youth draped in garb bearing the fanciful trademarks from one of the major sporting apparel/goods manufacturers comes to mind. These major sporting apparel/goods manufactures target these groups for two reasons. First, because they are peer pressure driven to have the newest, most fashionable designs. Second, because these age groups are the most athletically active and likely to purchase these products. There is little or no marketing of these products to older athletic Americans (predominantly in the 45 to 64 age group) and there are but a handful of athletic related products directed toward these elder athletes.

Therein lies the problem. The American populace is aging. The aging populace has the highest level of regular athletic participation than any of their aging predecessors. The medical profession professes the benefits of regular, rigorous exercise as the elixir of longevity. Organized sports for the 40+ age groups as well as gym memberships for the elder athletes abound at an all time high. Simply stated, older athletically involved athletes need trendy sporting shoes, apparel and related accessories that are directed at them. These will consider the older athlete's build, physical differences and needs. The current consumer focus does not consider shoes and apparel that fulfills the potential needs of these elder athletes such as size, shape, color, ease of putting on and off, and cost.

The major sporting apparel/goods manufacturers are missing an entire segment of the athletic population. That of the older 40+ athlete. To gain this consumer base requires more than just designing age reflective apparel. It requires a marketing strategy with an age related mantra/trademark and an old school marketing approach, such as directed mailings. These older athletes don't visit the shopping malls, read fashion magazines or shop online at the same level the younger athletes do. Nor do they comprise as high a percentage of their demographic segment as the younger athletes do. For this reason, expensive mass mailings are likely to fail. A successful marketing campaign will have to brand the older athlete with their own mantra such as “STILL DOING IT”™ that they can proudly display. This trademark would be the starting point to target the 45 to 64 age bracket athletes with “athleisue” products that combine looking like an athlete with leisure oriented.

The age related marketing system allows the major sporting apparel/goods manufacturers to be able to pin point the older athletes most likely to purchase their age directed wares. Armed with this information directed, mail out marketing may be sent to these individuals. Henceforth, such a system would fulfill a long felt need in the marketing industry. This new invention utilizes and combines known and new technologies in a unique and novel configuration to overcome the aforementioned problems and accomplish this.

### SUMMARY OF THE INVENTION

The general purpose of the present invention, which will be described subsequently in greater detail, is to provide an age related marketing system capable of developing the best possible leads for the directed mail out marketing to older athletes for the sale of are directed sporting apparel and goods. These leads will allow the major sports apparel and goods manufactures to successfully enter into an untapped segment of the population. It has many of the advantages mentioned heretofore and many novel features that result in a new marketing system and method which is not anticipated, rendered obvious, suggested, or even implied by any of the prior art, either alone or in any combination thereof.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements. There are, of course, additional features of the invention that will be described hereinafter and which will form the subject matter of the claims appended hereto.

### BRIEF DESCRIPTION OF THE DRAWINGS

FIG. 1 is a flowchart showing the general steps of the method of the age related marketing system.

### DETAILED DESCRIPTION

The above description will enable any person skilled in the art to make and use this invention. It also sets forth the best modes for carrying out this invention. There are numerous variations and modifications thereof that will also remain readily apparent to others skilled in the art, now that the general principles of the present invention have been disclosed. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

Much of today's marketing is online and brochure and catalog mail outs are diminishing because of the cost to develop, print and mail. However, these have been proven as the best way to solicit those over 45 years of age. (Older individuals do not interact with computers and smart devices as do most of todays' younger people do.) Logically, this would be the way to introduce a new line of athletic apparel (“athleisue” products) and related products to this segment of the population which includes 26.4% of the USA's census population containing 81,499,455 peple. However, a mass mail out to all of those over 45 would be a very expensive and unproductive exercise because the percentage of people over 45 that would buy these sports related items is not high enough, although it represents a viable market segment if solicited efficiently.

The age related marketing system and method disclosed herein uses an algorithmic based system to compare data in a weighted manner from private sector (purchased) and public sector databases against internet analytical data obtained from third parties to produce a list of potential customers from older athletic individuals who are likely to purchase clothing, shoes and sporting related or “athleisure” accessories in an ongoing capacity.

The athletic products envisioned for marketing are age modified apparel, shoes, age targeted supplements, age related physical accessories to address the physical needs of the aging athlete such as shoe inserts, arthritis braces and sleeves, relaxed (stretch/expandable) waistline pants, hook and loop fastener shoes and clothes, joint braces and supports, and the like. These too would be trademark branded accordingly with the new mantra.

The manufacturer/seller of the “athleisure” products develops statistical trends relating to the propensity of the older athlete to buy their products. This leads to a set of profiles for the consumer that they wish to target with their mail out advertisments. This set of profiles assigns different weights to their ages (with the lower ages having the highest weight), their athleticism, mobility and their long term personal preferences. An algorithm is developed that looks at the first two groupings (data set 1 and 2) of numerous sets of data collected into a data lake, groups all the available data for each individual, and applies the weighted analyses to the sets of data relating to the individual's athletic participation and mobility. This narrows data set 1 into group A considerably leaving only the names, ages and addresses of individuals in the targeted age group that are still athletically active and mobile travelers in a hierarch of ranking (IE—those belonging to multiple gyms would rank above those belonging to only one gym but those attending gyms more than 4 times a week would rank above everyone.) Thereafter, the algorithim looks the recently developed group A and data set 3 and applies its weighted analysis again narrowing group A to exclude all those who do not have long term personal preferences in shopping for related products or for viewing related products or activity websites. There is a hierarchical ranking now of individuals into a group B that most closely resemble the profile developed by the manufacturer/seller. (Again in this second analysis, for example, an individual that looks at more than three walkathon/marathon websites a year would rank higher than an individual that bought one pair of athletic shoes a year.)

The manufacturer/seller is now able to decided how much it wants to spend on mail out advertisements and can truncate the generated group B list accordingly. The members of group B have a profile that is built from weighted values of different sources of data that should relate closely to that person's propensity to consume these “athleisure” goods.

The first step in data acquisition is developing a data lake to analyze by importing and compiling data about these older athletes from multiple sources, both public and private. This involves the compilation of three distinct data sets.

The first type of data to be used to populate the data lake would be general/background data. Much of this data would be publicly available and comprised of simple personal data such as age, mailing address and names and would come from such sources as the DMV database, state voting registries, veteran's administration, and the like. However this type of information (ages, names and addresses) may also be purchased in the form of mailing lists from the private industry sector such as the AARP, life insurance companies, and the like.

This second set of data is purchased from the private sector and looks primarily at the level of athleticism and the level of mobility indicators of the individuals. Examples of where this level of athleticism indicator would be obtained is gym memberships (age, location and frequency of attendance), online shopping companies (name, address and high end sporting/walking shoes and apparel purchases and running clubs (membership names and addresses. Examples of where this this level of mobility indicator would be obtained is from airlines (names, addresses and frequency of travel) and travel companies like AAA (names, addresses and trips booked, travel literature obtained.) The compiled second data set is used to narrow the compiled first data set into a targeted group of individuals who's demographics and personal preferences best align with the manufacturer's own criteria for inclusion into the targeted mail out solicitation group.

The third set of data is long term personal preference data that has already been collected and is available as specifically analyzed statistical data from third parties. For example, statistics from internet shopping companies such as Amazon showing trending in shopping purchases could be obtained for all people who purchased more than one pair of athletic/walking shoes in the last 12 months or more than 3 items of sports related gear in the last 6 months. Similarly, internet browsing statistics such as Google Analytics could be obtained for individuals who viewed the websites for walkathon and marathon entry forms and other athletic on line event registrations. The compiled third data set is used to further narrow the now compiled first and second data sets into a targeted group of individuals who's spending habits and lifestyle preferences best align with the manufacturer's own criteria for inclusion into the targeted mail out solicitation group.

All of the data gathering and analysis is done on a special purpose computer that also operates a mail merge program and with its associated components prints the chosen addresses and the current postage on the individual advertisements.

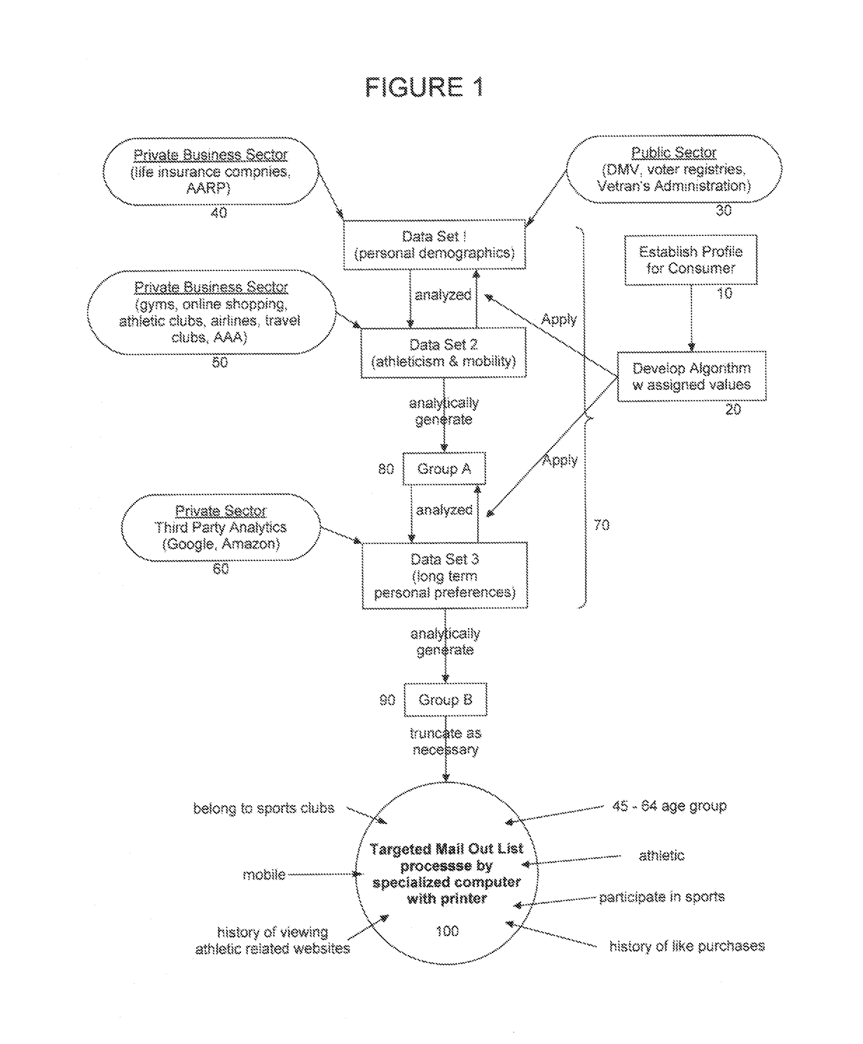

Looking at FIG. 1, the following steps provide the best possible leads for a directed, mail out marketing list:
1. Generate profile of the most likely elder athlete to consume the products 10;
2. Develop algorithm with weighted values assigned to the data most likely to fit the profile 20;
3. Obtain personal demographic data from public 30 and private sources 40;
4. Obtain athleticism and mobility data from private sources 50;
5. Purchase analytic personal shopping and internet browsing data from online retailers and browser analytics 60;
6. Assimilate/import all purchased data into a data lake for master data management 70;
7. Develop a hierarchical first group analyzing personal demographic data and athleticism and mobility data from the data lake 80;
8. Develop a hierarchical second group analyzing first group data and personal shopping and internet viewing preferences from the data lake 90; and
9. Mail merge the individuals from the second group by printing their name and address on an advertisement 100.

Although utilizing the three different data sources described above, the system herein may also use a fourth set of data scoured from the internet. This would look at much smaller data collections generally geographically localized. This would include websites, newletters, blogs, news feeds and the like, directed to any specific indicator that the seller of the goods would clearly identify potential buyers. For example, if the seller believed that a high percentage of elder athletes that participated in Senior Olympics would wear the “athleisure” shoes and apparel branded with the “Still Doing it” logo, then scouring the internet for data found in chatrooms about Senior Olympians may be used as a fourth data set. The algorithm would be expanded to place weighted values on this data and to incorporate this data set into a additional level of the analysis.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Having thus described the invention, what is claimed as new and desired to be secured by Letters Patent is as follows:

1. An age related marketing method comprising the steps of:
obtaining personal demographic data from public and private sources;
obtaining athleticism and mobility data form private sources;
obtaining analytic personal shopping and internet browsing data from online retailers and browser analytics;
assimilating all purchased data into a data lake for master data management;
generating a profile of the most likely elder athlete to consume the products;
developing an algorithm with weighted values assigned to the data most likely to fit the profile;
developing a hierarchical first group analyzing personal demographic data and athleticism and mobility data from the data lake;
developing a hierarchical second group analyzing first group data and personal shopping and internet viewing preferences from the data lake; and
mail merging the individuals from the second group by printing their name and address on an advertisement.
